(19) United States
(12) Patent Application Publication
(10) Pub. No.: US 2015/0079428 A1
(43) Pub. Date: Mar. 19, 2015

(54) BATTERY MODULE

(71) Applicant: Samsung SDI Co., Ltd., Yongin-si (KR)

(72) Inventor: Tae-Ho KWON, Yongin-si (KR)

(73) Assignee: Samsung SDI Co., Ltd., Yongin-si (KR)

(21) Appl. No.: 14/287,628

(22) Filed: May 27, 2014

(30) Foreign Application Priority Data
Sep. 17, 2013 (KR) 10-2013-0111638

(51) Int. Cl. H01M 2/12

(52) U.S. Cl. CPC H01M 2/1235
USPC 429/56; 429/53

(57) ABSTRACT

A battery module including a plurality of battery cells aligned in one direction, the plurality of battery cells each having a vent on a top surface thereof; and at least one vent cover covering the vent and covering side surfaces of the plurality of battery cells, wherein one vent cover covers outer side surfaces of outermost battery cells among the aligned plurality of battery cells, or a plurality of vent covers cover side surfaces of a battery cell of the plurality of battery cells.

### CROSS-REFERENCE TO RELATED APPLICATION

Korean Patent Application No. 10-2013-0111638, filed on Sep. 17, 2013, in the Korean Intellectual Property Office, and entitled: “Battery Module,” is incorporated by reference herein in its entirety.

### BACKGROUND

1. Field

Embodiments relate to a battery module.

2. Description of the Related Art

A high-power battery module using a non-aqueous electrolyte with high energy density has recently been developed. The high-power battery module may be configured as a large-capacity battery module manufactured by connecting a plurality of battery cells in series so as to be used in driving motors of devices requiring high power, e.g., electric vehicles or the like. Further, a battery pack may be configured by electrically connecting such a plurality of battery modules to one another.

### SUMMARY

Embodiments are directed to a battery module.

The embodiments may be realized by providing a battery module including a plurality of battery cells aligned in one direction, the plurality of battery cells each having a vent on a top surface thereof; and at least one vent cover covering the vent and covering side surfaces of the plurality of battery cells, wherein one vent cover covers outer side surfaces of outermost battery cells among the aligned plurality of battery cells, or a plurality of vent covers cover side surfaces of a battery cell of the plurality of battery cells.

The vent cover may include a first cover covering the vent; and second covers extending at sides of the first cover, the second covers each covering a side surface of a battery cell of the plurality of battery cells.

The first cover may be spaced apart from the vent.

The battery module may further include an absorbing member on one surface of the first cover, the one surface being opposite to the vent.

The absorbing member may absorb at least one of an internal gas or electrolyte exhausted or discharged through the vent when the vent is fractured.

The second covers may press inwardly on side surfaces of the battery cell of the plurality of battery cells.

The battery module may further include a heat insulating member between one of the second covers and a corresponding side surface of the battery cell of the plurality of battery cells.

The heat insulating member may include at least one of elastic rubber, a urethane, or silicon.

An inner surface of each second cover may include at least one protruding portion thereon.

The second covers may extend from only portions of respective sides of the first cover, and one second cover extending from one portion of one side of the first cover may be offset with respect to another second cover extending from another portion of another side of the first cover.

The battery module may further include a shielding member between adjacent battery cells of the plurality of battery cells, wherein the second covers cover the outer side surfaces of the outermost battery cells among the aligned plurality of battery cells, and wherein the first cover includes at least one insertion hole therein, the shielding member being inserted into the insertion hole.

The battery module may further include a barrier between adjacent battery cells of the plurality of battery cells, wherein the second covers cover the outer side surfaces of the outermost battery cells among the aligned plurality of battery cells.

The battery module may further include a shielding portion extending upwardly from a partial area of a top surface of the barrier, wherein the shielding portion contacts a bottom surface of the first cover.

The barrier may further include one or more protruding portions thereon.

The barrier may be a heat insulating member.

### BRIEF DESCRIPTION OF THE DRAWINGS

Features will be apparent to those of skill in the art by describing in detail exemplary embodiments with reference to the attached drawings in which:

FIG. 1 illustrates a perspective view showing a battery module according to an embodiment.

FIG. 2 illustrates a side view of a coupling relationship between a battery cell and a vent cover according to an embodiment.

FIG. 3 illustrates a side view of a coupling relationship between the battery cell and the vent cover according to another embodiment.

FIG. 4 illustrates a side view of a coupling relationship between the battery cell and the vent cover portion according to still another embodiment.

FIG. 5 illustrates a perspective view of a vent cover according to an embodiment.

FIG. 6 illustrates a perspective view showing the battery module to which the vent cover of FIG. 5 is coupled.

FIG. 7 illustrates a perspective view showing a battery module according to another embodiment.

FIG. 8 illustrates a perspective view showing a battery module according to still another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. It will be understood that when an element is referred to as being “between” two elements, it can be the only element between the two elements, or one or more intervening elements may also be present.

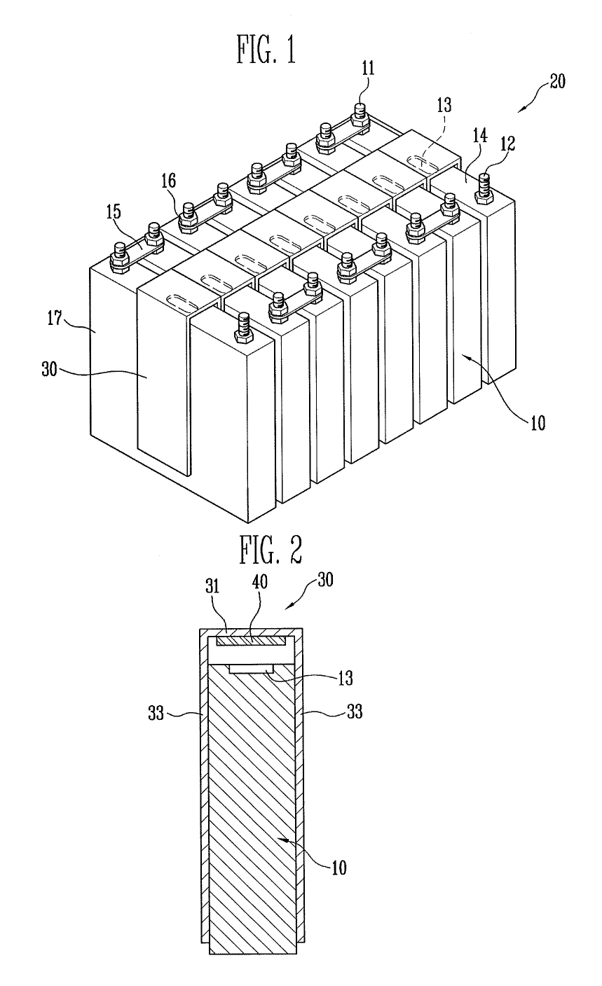

FIG. 1 illustrates a perspective view showing a battery module according to an embodiment.

Referring to FIG. 1, the battery module 100 according to this embodiment may be used by forming, as a set, a plurality of battery modules 100 connected to one another, in order to use high power. Each battery module 100 may be formed by aligning a plurality of battery cells 10 in one direction. The battery cells 10 may be electrically connected to each other, and each battery cell 10 may include a battery case of which one surface or side is opened, and an electrode assembly and an electrolyte, which are accommodated in the battery case.

The electrode assembly and the electrolyte may generate energy through an electrochemical reaction therebetween, and the battery case may be hermetically sealed with a cap plate. A terminal portion 11 and 12 and a vent 13 may be provided to a top surface 14 of the battery cell 10. The terminal portion 11 and 12 may include positive and negative electrode terminals 11 and 12 having different polarities from each other. The vent 13 may be a safety means or mechanism of the battery cell 10, and may act as a passage through which gas generated inside the battery cell is exhausted to the outside of the battery cell 10. The positive and negative electrode terminals 11 and 12 of adjacent battery cells 10 may be electrically connected through a bus-bar 15. The bus-bar 15 may be fixed to the positive and negative electrode terminals 11 and 12, using a member, e.g., a nut 16. A vent cover 30 may cover the vent 13 and at least one side surface, e.g., side surfaces, of the battery cell 10.

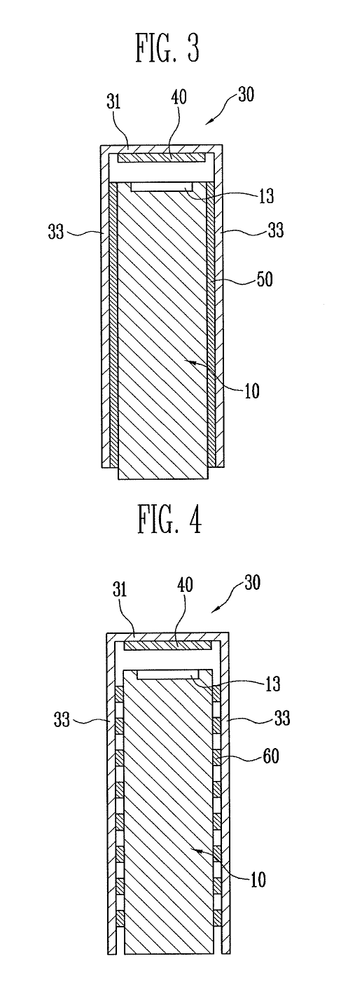

FIG. 2 illustrates a side view of a coupling relationship between a battery cell and a vent cover according to an embodiment.

Referring to FIG. 2, the vent cover 30 may include a first cover that covers the vent 13, and second covers 33 respectively extending from sides, e.g., both sides, of the first cover 31. The second covers 33 may each cover a respective side surface of a corresponding one of the battery cells 10.

The first cover 31 may be spaced apart from the vent 13. The second covers 33 may be coupled to, contact, or be adhered closely to the side surfaces of the corresponding one of the battery cells 10.

A swelling phenomenon (in which gas or the like is generated and filled inside a battery cell at a high temperature/high voltage) may occur in the battery cell 10. In a case where the internal pressure of the battery cell 10 is increased due to the generation of the gas, the vent 13 in the top surface of the battery cell 10 may be fractured, so that the internal gas may be exhausted to the outside of the battery cell 10. When the vent 13 is fractured, a spark could be temporarily generated, and the electrolyte may be discharged, together with the internal gas, to the outside of the battery cell 10.

In this case, the first cover 31 (covering the vent 13) and the second covers 33 may help reduce the likelihood of and/or prevent the spark (that may be generated when the vent 13 is fractured) from, e.g., adversely, influencing an adjacent battery cell 10. In addition, the first and second covers 31 and 33 may help prevent the electrolyte (discharged from the inside of the battery cell 10) from being transferred or exposed to the adjacent battery cell 10, so that the performance of the adjacent battery cell 10 may be constantly maintained, thereby improving stability.

In an implementation, an absorbing member 40 may be disposed on one surface of the first cover 31 that is opposite to the vent 13, e.g., the one surface of the first cover 31 may be opposite to and/or face the vent 13. The absorbing member 40 may absorb the gas or electrolyte that is exhausted or discharged from the inside of the battery cell 10, and may help prevent the electrolyte from being moved or exposed to another battery cell 10.

In a case where the swelling phenomenon occurs in the battery cell 10, the side surfaces of the battery cell 10 may be generally swelled by the pressure increased inside the battery cell 10. In this case, performance of the battery cell 10 may be decreased. According to an embodiment, the second covers 33 may be respectively coupled to or adhered closely to the side surfaces, e.g., both side surfaces, of the battery cell 10, and may help maintain performance of the battery cell 10 before the vent 13 is fractured by helping to prevent swelling of the battery cell 10. For example, the second covers 33 may press inwardly on the sides of the battery cell 10 in order to help suppress the swelling of the battery cell. In an implementation, the second covers 33 may be formed of a material having high strength in order to help reduce and/or prevent the swelling phenomenon (caused by an increase in the internal pressure of the battery cell 10).

FIG. 3 illustrates a side view of a coupling relationship between the battery cell and the vent cover according to another embodiment.

Referring to FIG. 3, components of the battery module except for a heat insulating member 50 may be substantially identical to those of the embodiment shown in FIG. 2. Therefore, the substantially identical components are designated by like reference numerals, and repeated detailed descriptions thereof may be omitted.

As shown in FIG. 3, the heat insulating member 50 may be between at least one of the second covers 33 and a corresponding side surface of the battery cell 10.

In a case where the swelling phenomenon occurs in the battery cell 10, heat may be generated inside the battery cell 10. If the heat were to be conducted to an adjacent battery cell 10, performance of the adjacent battery cell 10 could be decreased. Thus, the heat insulating member 50 may help prevent the heat from being conducted to the adjacent battery cell 10, thereby maintaining the performance of the adjacent battery cell 10.

In an implementation, the heat insulating member 50 may be formed of or may include at least one of, e.g., elastic rubber, a urethane, or silicon. For example, the heat insulating member may be formed of various suitable materials that are able to shield or insulate against heat.

FIG. 4 illustrates a side view of a coupling relationship between the battery cell and the vent cover according to still another embodiment.

Referring to FIG. 4, components of the battery module except for a protruding portion 60 may be substantially identical to those of the embodiment shown in FIG. 2. Therefore, the substantially identical components are designated by like reference numerals, and repeated detailed descriptions thereof may be omitted.

As shown in FIG. 4, at least one protruding portion 60 may be formed on an inner surface of at least one of the second covers 33. The protruding portion 60 may form or provide a space between the at least one second cover 33 and the corresponding battery cell 10 by allowing the one second cover 33 and the battery cell 10 to be spaced apart from each other. Thus, the protruding portion 60 perform a barrier function, and may provide a movement path of a coolant, e.g., a coolant path, for cooling the battery cell 10.

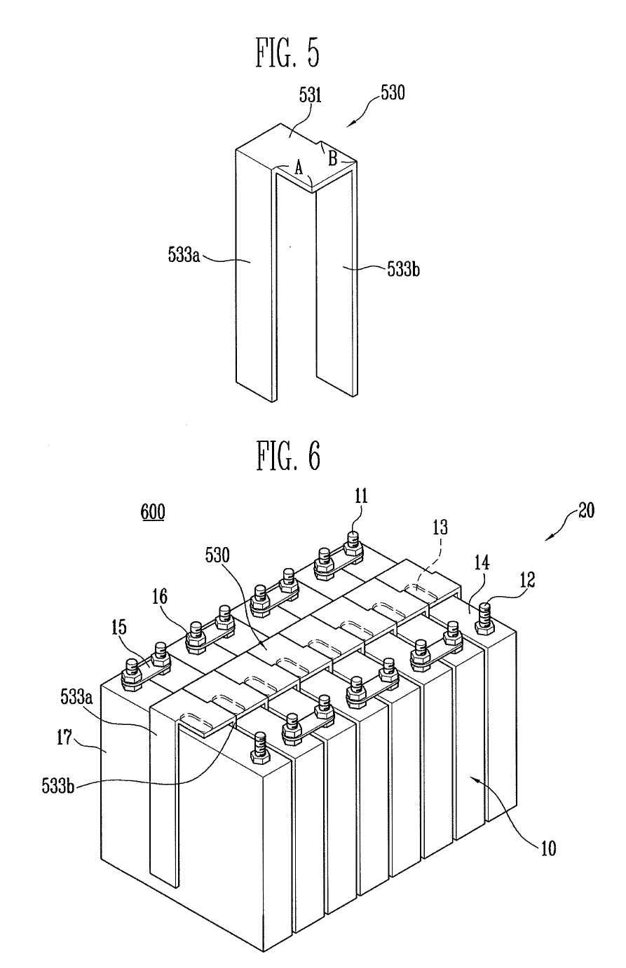

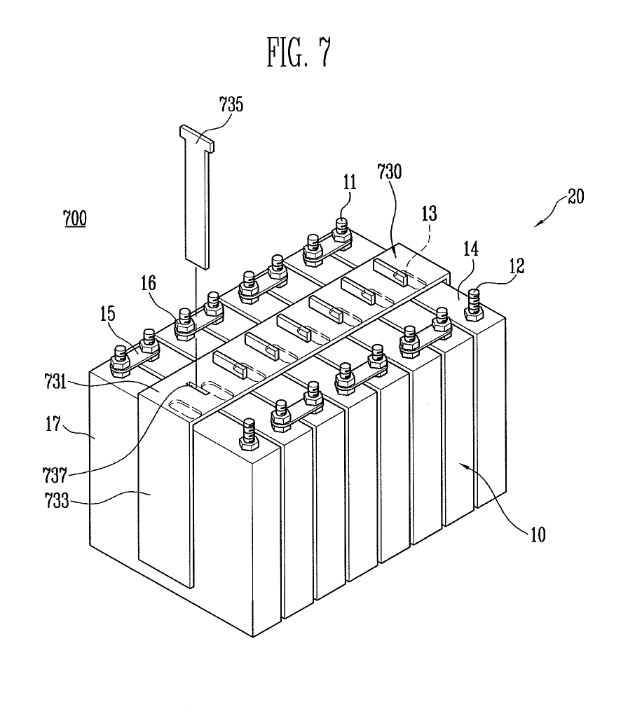

FIG. 5 illustrates a perspective view of a vent cover according to an embodiment. FIG. 6 illustrates a perspective view showing the battery module to which the vent cover of FIG. 5 is coupled.

In a case where the vent cover 30 is disposed at or on each battery cell 10 (e.g., in which each battery cell 10 is associated with one of the vent covers 30) as shown in FIG. 1, the second covers 33 may be overlapped with each other between the battery cell 10. Therefore, an entire thickness of the battery module 100 (in the alignment direction of the battery cells 10) may be increased.

Referring to FIG. 5, second covers 533a and 533b of the vent cover 530 may respectively extend from only portions of sides, e.g., both sides, of a first cover 531. For example, one second cover 533b may extend from a portion B of one side of the first cover 531, and another second cover 533a may extend from another portion of another side of the first cover 531 that is adjacent to a portion A of the other side of the first cover 531 (e.g., portion A may overlap with or may be symmetrical with portion B of the one side of the first cover 531). For example, portion A (at which the second cover 533a is not extended from the other side of the first cover 531) may correspond with or overlap with portion B (from which the one second cover 533b extends on the one side of the first cover 531). For example, the second covers 533a and 533b of one vent cover 530 may be offset or asymmetrical with respect to one another.

Thus, in a case where a plurality of vent covers 530 are aligned in a row, as shown in FIG. 6, the second covers 533a and 533b may alternately extend at sides, e.g., both sides, of the first cover 531. Hence, the second covers 533a and 533b of adjacent vent covers 530 (between the battery cells 10) may not be overlapped with each other (e.g., in the aligning direction of the battery cells 10). Thus, an entire thickness of the battery module 600 may be decreased, as compared with the thickness of the battery module of FIG. 1.

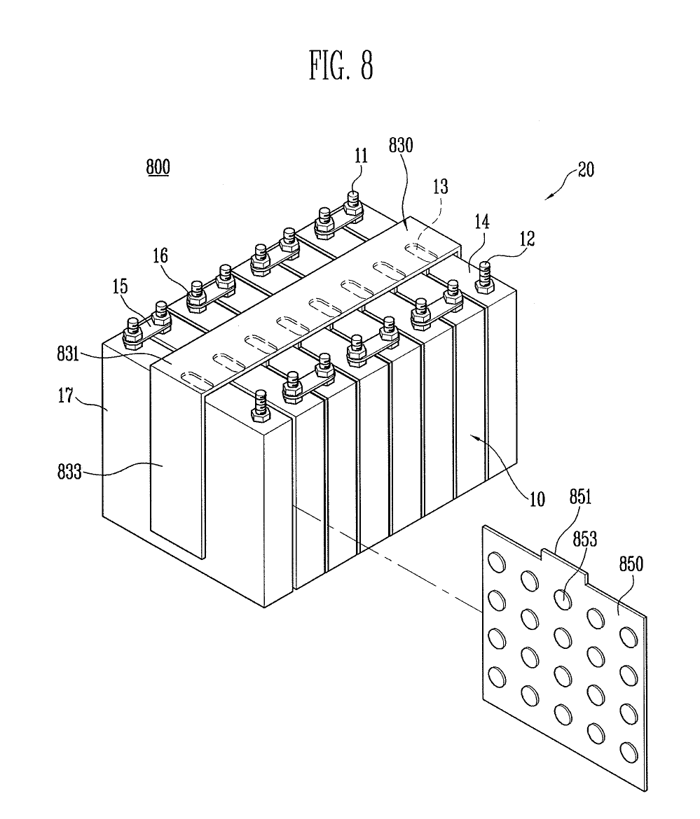

In an implementation, the vent cover 30 or 530 may be provided in plural numbers in the battery module 100 or 600 to respectively cover the vent and side surfaces of each battery cell 10 of the plurality of battery cells 10. In an implementation, only one vent cover may be disposed in the battery module, to thus cover only outer side surfaces of outermost battery cells among the plurality of battery cells. This will be described below with reference to FIGS. 7 and 8.

FIG. 7 illustrates a perspective view showing a battery module according to another embodiment.

Referring to FIG. 7, components of the battery module except a vent cover 730 may be substantially identical to those of the embodiment shown in FIG. 1. Therefore, the substantially identical components are designated by like reference numerals, and repeated detailed descriptions thereof may be omitted.

The vent cover 730 may include a first cover 731 covering the vent 13 on top surfaces 14 of each battery cell 10 of the plurality of battery cells 10, and second covers 733 respectively covering side surfaces of outermost battery cells 10 of the plurality of battery cells 10.

The first cover 731 may be spaced apart from the vent 13. An absorbing member (40, see FIG. 2) may be on one surface of the first cover 731 that is opposite to or facing the vent 13 of each of the plurality of battery cells 10.

A shielding member 735 may be disposed between battery cells 10 of the plurality of battery cells 10. At least one insertion hole 737 (having the shielding member 735 inserted thereinto) may be provided on a top surface of the first cover 731.

The shielding member 735 may partition a space between the top surfaces of the plurality of battery cells 10 and the first cover 731 for each battery cell. In a case where the vent 13 of any one battery cell 10 is fractured, the shielding portion 735 may help prevent a spark (that may be generated in the vent 13 of the battery cell 10) or an electrolyte (discharged from the battery cell 10) from being transferred to or affecting an adjacent battery cell 10.

FIG. 8 illustrates a perspective view showing a battery module according to still another embodiment.

Referring to FIG. 8, components of the battery module except for a vent cover 830 and a barrier 850 may be substantially identical to those of the embodiment shown in FIG. 1. Therefore, the substantially identical components are designated by like reference numerals, and repeated detailed descriptions thereof may be omitted.

As shown in FIG. 8, barriers 850 may be respectively interposed between battery cells 10 of the plurality of battery cells 10.

A shielding portion 851 may extend upwardly from a partial area of a top surface of the barrier 850, and may be coupled to, contact, or be adhered closely to a bottom surface of a first cover 831. For example, a width of the shielding portion 851 may be less than an overall width of the barrier 850 (e.g., the side of the barrier 850) from which the shielding portion 851 extends. Thus, the shielding portion 851 may partition a space between the top surfaces of the plurality of battery cells 10 and the first cover 831 for each battery cell. The shielding portion 851 may help prevent a spark (that may be generated in the vent 13 of any one battery cell 10) or an electrolyte (discharged from the battery cell 10) from being transferred to or affecting an adjacent battery cell 10.

In an implementation, the barrier 850 may include one or more protruding portions 853. The protruding portions 853 may be provided on at least one of first and second surfaces of the barrier 850. The protruding portions 853 may be provided on the surface where the barrier 850 and the battery cell 10 contact each other. In an implementation, a section of the protruding portion 853 may be formed in a circular, rounded, or quadrangular shape, and a number and positions of the protruding portions 853 may be variously modified according the to design of the battery module.

The barrier 850 may be interposed between adjacent battery cells 10, to allow the adjacent battery cells 10 to be spaced apart from each other. Therefore, an empty or open space may be provided between, e.g., inner parts of, the barrier 850 and the battery cell 10 by the protruding portions 853. The space may act as a path through which heat generated in the battery cell 10 is discharged, so that the heat may not be accumulated. In an implementation, the space may become a path through which a cooling medium for cooling the battery cell 10 is moved, e.g., a coolant path.

In order to control swelling of the battery cell 10, which may occur in a process of charging/discharging the battery cell 10, the barrier 850 may perform, together with a second cover 833, a function of compressing the battery cell 10 with a predetermined pressure or more.

The barrier 850 may be made of a heat insulating member that is capable of shielding or insulating against heat. The barrier 850 may help prevent heat that is generated inside the battery cell 10 from being conducted to an adjacent battery cell 10 when swelling of the battery cell 10 occurs.

By way of summation and review, a swelling phenomenon (in which gas or the like is generated and filled inside a battery cell at a high temperature/high voltage) may occur in a battery cell. Therefore, a vent may be provided in a top surface of the battery cell. In a case where the internal pressure of the battery cell is increased due to the gas generated inside the battery cell, the gas may be exhausted to the outside of the battery cell by fracturing the vent.

When the vent is fractured, a spark may be temporarily generated, or an electrolyte inside the battery cell may be discharged together with the exhausted gas. In a case where a vent of a battery cell among a plurality of battery cells is fractured, the fracture of the vent may have an influence or effect on another adjacent battery cell.

The embodiments provide a battery module exhibiting improved stability, even when a vent of a battery cell is fractured.

According to an embodiment, although the vent of any one battery cell among the plurality of battery cells may be fractured, the performance of an adjacent battery cell may be constantly maintained, thereby improving stability.

Further, swelling of the battery cell may be reduced and/or prevented, so that it is possible to maintain the performance of the battery cell before the vent of the battery cell is fractured.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells aligned in one direction, the plurality of battery cells each having a vent on a top surface thereof; and
at least one vent cover covering the vent and covering side surfaces of the plurality of battery cells,
wherein:
one vent cover covers outer side surfaces of outermost battery cells among the aligned plurality of battery cells, or
a plurality of vent covers cover side surfaces of a battery cell of the plurality of battery cells.

2. The battery module as claimed in claim 1, wherein the vent cover includes:
a first cover covering the vent; and
second covers extending at sides of the first cover, the second covers each covering a side surface of a battery cell of the plurality of battery cells.

3. The battery module as claimed in claim 2, wherein the first cover is spaced apart from the vent.

4. The battery module as claimed in claim 3, further comprising an absorbing member on one surface of the first cover, the one surface being opposite to the vent.

5. The battery module as claimed in claim 4, wherein the absorbing member absorbs at least one of an internal gas or electrolyte exhausted or discharged through the vent when the vent is fractured.

6. The battery module as claimed in claim 2, wherein the second covers press inwardly on side surfaces of the battery cell of the plurality of battery cells.

7. The battery module as claimed in claim 2, further comprising a heat insulating member between one of the second covers and a corresponding side surface of the battery cell of the plurality of battery cells.

8. The battery module as claimed in claim 7, wherein the heat insulating member includes at least one of elastic rubber, a urethane, or silicon.

9. The battery module as claimed in claim 2, wherein an inner surface of each second cover includes at least one protruding portion thereon.

10. The battery module as claimed in claim 2, wherein:
the second covers extend from only portions of respective sides of the first cover, and
one second cover extending from one portion of one side of the first cover is offset with respect to another second cover extending from another portion of another side of the first cover.

11. The battery module as claimed in claim 2, further comprising a shielding member between adjacent battery cells of the plurality of battery cells,
wherein the second covers cover the outer side surfaces of the outermost battery cells among the aligned plurality of battery cells, and
wherein the first cover includes at least one insertion hole therein, the shielding member being inserted into the insertion hole.

12. The battery module as claimed in claim 2, further comprising a barrier between adjacent battery cells of the plurality of battery cells,
wherein the second covers cover the outer side surfaces of the outermost battery cells among the aligned plurality of battery cells.

13. The battery module as claimed in claim 12, further comprising a shielding portion extending upwardly from a partial area of a top surface of the barrier,
wherein the shielding portion contacts a bottom surface of the first cover.

14. The battery module as claimed in claim 12, wherein the barrier further includes one or more protruding portions thereon.

15. The battery module as claimed in claim 12, wherein the barrier is a heat insulating member.
